(19) United States
(12) Patent Application Publication
(10) Pub. No.: US 2016/0001629 A1
(43) Pub. Date: Jan. 7, 2016

(54) COOLING DEVICE FOR A MOTOR VEHICLE

(71) Applicant: VOLKSWAGEN AKTIENGESELLSCHAFT, Wolfsburg (DE)

(72) Inventor: Michael ROHR, Wolfsburg (DE)

(21) Appl. No.: 14/768,061

(22) PCT Filed: Feb. 5, 2014
(86) PCT No.: PCT/EP2014/052194

§ 371 Date: Aug. 14, 2015

(30) Foreign Application Priority Data
Feb. 16, 2013 (DE) 10 2013 002 707.1
Feb. 4, 2014 (DE) 10 2014 201 991.5

(51) Int. Cl. B60H 1/00

(52) U.S. Cl. CPC B60H 1/00528

(57) ABSTRACT

A cooling device for a motor vehicle comprises at least two cooling elements, which are arranged in succession in different, in particular parallel, planes so as to be permeable to supplied ambient air and which are interconnected by means of plug-in connections, wherein at least one first plug-in connection is disposed so as to be displaceable along a first spatial axis during assembly and at least one second plug-in connection is disposed so as to be displaceable along a second spatial axis transversally to the first spatial axis during assembly, and the at least one of the first plug-in connections is disposed so as to be limitedly displaceable in the direction of at least one spatial axis in its fixing position, which connects the cooling elements, in the plane parallel to the cooling elements in each case. The at least one first plug-in connection is arranged on a first edge, in particular on a first collecting device of the cooling elements, so as to form a floating bearing face, and the at least one second plug-in connection is arranged on a second edge lying opposite the first edge, in particular on a second collecting device, so as to form a fixed bearing face.

The present invention relates to a cooling device for a motor vehicle, the cooling device including at least two cooling elements, which are successively disposed in different, in particular parallel planes to allow the incoming ambient air to flow therethrough, and which are interconnected by plug-in connections; at least one first plug-in connection being designed to be movable in a first direction, and at least one second plug-in connection being designed to be movable in a second direction transversely to the first direction; and, in the fixing position thereof that connects the cooling elements, at least one of the first plug-in connections being designed to have restricted movability in at least one direction, in each case in the plane parallel to the cooling elements.

In modern internal combustion engines, a low-temperature radiator, also referred to as a secondary radiator, serves for the reverse-flow cooling of the water used for cooling the engine. A low-temperature radiator is often used instead of an intercooler. In particular, a low-temperature radiator is used for cooling ancillary components, such as turbochargers, generators, electric drives. Alternatively, a separate intercooler mounted on the engine is used.

On the other hand, high-temperature radiators, also referred to as main radiators, are used for cooling the combustion chamber, the cylinder, and the cylinder head. It is also common to use the high-temperature radiator to cool the engine oil, respectively the transmission fluid.

Intercoolers are used as auxiliary units in internal combustion engines and serve for cooling already precompressed air to be supplied to these internal combustion engines for purposes of further compression and, thus, for augmenting the power output by the internal combustion engines. To that end, the intercooler, which constitutes a heat exchanger, has a radiator core having a tube system that is traversed by the flow of a coolant. To improve the exchange of heat, the tube system is provided with fins or gills.

The high-temperature radiator and the low-temperature radiator are heat exchangers, which are mounted in the front area of the vehicle, viewed in the travel direction thereof, where they are exposed to the head-on air stream. A fan, which subjects the high-temperature radiator and the low-temperature radiator to an air stream as needed, even when the vehicle is at a standstill, is preferably disposed upstream of the high-temperature radiator and the low-temperature radiator, viewed in the direction of travel. Together, high-temperature radiators and/or low-temperature radiators and/or fans form a radiator core. Configured on the radiator core as means of attachment among themselves are mounting flanges or mounting rails, to which the individual elements are fastened by optionally likewise specially designed screws or bolts. For that purpose, specially designed nuts are optionally inserted in the mounting flanges or mounting rails.

The German Patent Application DE 43 32 919 A1, which seeks to patent a cooling element having a further cooling element fastened thereto, describes a fastening configuration having means of attachment. The means of attachment are constituted in each case at one of the cooling elements of a form-fittingly adjoining, self-locking screw in a guideway having an elastic lining, and of an opening for this screw formed at the narrow side of another one of the cooling elements. The screw is able to engage the rim edge of the opening from behind. The fastening is accomplished by insertion of the same from above into the intercooler and by using locking elements configured in the lower region for position locking, and by subsequently screwing the screws into the openings.

Configuring or forming fastening means on the radiator core for a cooling air housing or a cooling-air supply hood surrounding the same is a relatively complex process because of the production effort entailed by metal machining processes, but also in terms of assembly and disassembly.

The German Patent Application DE 196 45 507 A1 also discusses a fastening configuration for an air supply hood on an intercooler that has two mutually opposing air guide boxes on a block-shaped radiator core for the charge air inlet and the charge air outlet. The air supply hood is detachably mounted on the cooling air inlet side by fastening elements on the air guide boxes, as well as therebetween. This is accomplished by at least one retaining tab made of plastic having at least one tongue of an essentially rectangular cross section that is configured on the one air guide box and, on the side opposite the retaining tab, by two latching members of plastic that are provided for two latching elements that are spaced at a distance on the other air guide box.

The German Patent Application DE 10 2006 037 761 A1 also already discusses a fastening configuration for an intercooler coupled to a radiator, it being possible for the radiator to be locked in position, optionally together with or also without the intercooler, on a retaining structure in the front end of the motor vehicle, in order to thereby provide a modular design. The fastening means of the radiator have a downwardly projecting adapter that conforms with the respective adapter of the intercooler, allowing the radiator to be fixed to the retaining structure, even without interconnection of the intercooler.

The printed publication DE 10 2009 059 930 A1 describes a cooling device where at least two cooling elements are fastened to each other by plug-in connections and are successively disposed, in particular in parallel planes, to allow the incoming ambient air to flow therethrough. In the fixing position thereof that connects the cooling elements, the plug-in connections are each designed to have restricted movability in at least one direction in the plane parallel to the cooling elements, at least one first plug-in connection being movably designed in a first direction, and at least one second plug-in connection being movably designed in a second direction transversely to the first direction.

It is an object of the present invention to provide a cooling device for an internal combustion engine of a motor vehicle that will make possible a rapid assembly and a high process reliability. It is also intended that the manufacturing outlay, in particular the number of parts to be handled during assembly, be reduced.

This objective is achieved by a fastening configuration in accordance with the features set forth in claim 1. Especially advantageous embodiments of the present invention are recited in the dependent claims.

Thus, in accordance with the present invention, a cooling device is provided where the at least one first plug-in connection, forming a non-locating bearing side, is configured on a first edge, in particular on a first collecting device of the cooling elements; and the at least one second plug-in connection, forming a locating bearing side, is configured on a second edge opposite the first edge, in particular on a second collecting device.

The cooling elements are designed as heat exchangers that include numerous, side-by-side disposed tubular sections that are traversable by the flow of a coolant. The heat exchangers also include two mutually opposing collecting devices that are likewise traversable by the flow of the coolant and that are fluidically interconnected by the individual, side-by-side disposed tubular sections. The two collecting devices each have a plurality of through holes for receiving the open end regions of the tubular sections.

In a surprisingly simple manner, this makes it hereby possible at the same time to realize an effortless, in particular even toolless connection of the cooling elements, on the one hand, as well as a problem-free mounting of the thus created structural unit on a bearing structure in the front area of the motor vehicle, on the other hand, which, at the same time, makes it possible to compensate for different thermal expansions of the cooling elements because of the restricted movability. Thus, the present invention thereby provides a simple modular design that makes it possible to easily combine cooling elements whose operating temperatures and associated rates of thermal expansion differ substantially. This movability also serves at the same time to compensate for manufacturing tolerances, thereby simplifying assembly. The cooling elements may be configured in a series connection or parallel connection of the coolant so as to be successively traversable by the flow of the coolant. However, these cooling elements are preferably disposed independently of one another in different coolant circuits, in particular, one cooling element being configured as a low-temperature radiator and/or one cooling element as a high-temperature radiator. The assembly may be simplified by functionally dividing the plug-in connections into a non-locating bearing side and a locating bearing side. This is preferably carried out in an uninterrupted movement where the cooling elements are moved, first translationally and then rotationally, toward each other. In accordance with the present invention, in the fixing position on the locating bearing side, the thermal expansion is provided in only one direction parallel to the plane of the cooling elements, while on the non-locating bearing side, the thermal expansion is possible in both directions oriented parallel to the plane of the cooling elements.

The inventive embodiment of the plug-in connection serves, in particular, for the pairwise fastening of cooling elements of a cooling device to one another. Besides the at least one heat exchanger, also referred to as a radiator, the cooling elements of a cooling device may also be a fan shroud, respectively a condenser.

To interconnect the cooling elements, plug-in connections are used that are constituted of a male connector member configured on one of the cooling elements and of a sleeve that receives the male connector member in the fixing position when the cooling elements are assembled to each other. The components, male connector member and sleeve, make it possible to provide a form-locking connection which is effective in a plurality of spatial axes and whose tolerances suffice for accommodating thermal expansions. One specific embodiment of the present invention provides that a sleeve have two plane-parallel bounding surfaces that are associated in the fixing position with plane-parallel friction surfaces of a male connector member. The bounding surfaces are spaced apart by a slightly larger distance than are the friction surfaces.

The present invention provides that two cooling elements be assembled to each other in one assembly direction that essentially features an angle smaller than 30 degrees, preferably 15 degrees to the plane of the radiator. The cooling elements are brought together, and the male connector members are placed in the sleeves of the at least one first plug-in connection. This ideally translational movement of the cooling elements toward one another results in the effortless insertion thereof from above or laterally, the first plug-in connection defining the end position. The cooling elements are subsequently fixed in position relative to one another. To that end, the cooling elements are preferably rotated toward each other. The assembly direction, in particular of the at least one second plug-in connection, is essentially oriented orthogonally to the plane of the cooling elements. Thus, the second plug-in connection secures the cooling elements in position transversely to the particular main extension plane, thereby achieving a rapid and simple connection.

The advantage of a simple insertion of the plug-in connection is derived because, as described above, a sleeve has two plane-parallel bounding surfaces that, in the fixing position thereof, are associated with plane-parallel friction surfaces of a male connector member, and the bounding surfaces are spaced apart by a distance slightly greater than that of the friction surfaces relative to one another. Since the bounding surfaces are disposed parallel to one another, but somewhat laterally offset from one another, the male connector member may be readily inserted, on the one hand, and moved about an axis of rotation, on the other hand, allowing it to be readily co-rotated and displaced with the collecting device, in the process, however, ensuring a strictly defined distance in an end position. This strictly defined distance is derived from the distance of the parallel friction surfaces and the corresponding offset relative to each other. Such an insertion and, ultimately, also snap-fit connections and/or latching clips and/or connection means thus ensure a secure and fixed retention in the case of the first plug-in connection, and a secure and fixed retention in the case of the second plug-in connection.

The bounding surfaces are disposed parallel to one another, however, at an offset relative to the first spatial axis. The result is a stepped formation, as shown in the figures.

The first assembly direction, respectively the second assembly direction are oriented to allow a pivoting into place in that the bounding surfaces of a sleeve of at least one first plug-in connection feature mutually facing end edges that are spaced apart by a greater distance than are the bounding surfaces. Thus, the male connector member may be initially disposed at an angle in the sleeve. In response to movement in the second assembly direction, the friction surfaces are then placed against the bounding surfaces. This inventive assembly movement makes it possible to provide a cooling device where the components, such as connector members of individual cooling elements, embrace another cooling element on a plurality of sides, making it very compact in construction. Moreover, the assembly movement permits a rapid and reliable assembly since the assembler only needs to initially concentrate on the first assembly direction when connecting the first plug-in connection, and then merely needs to direct his/her attention to the second assembly direction to connect the second plug-in connection. There is no need here to coordinate two different directions of movement simultaneously.

In summary, it has proven to be beneficial that the at least one first plug-in connection, preferably all first plug-in connections of the non-locating bearing side is/are designed in each case in the position thereof that connects the cooling elements, fixing them into place, to have restricted movability in the direction that is orthogonal to the plane of the cooling elements. Moreover, it has proven to be advantageous that the at least one second plug-in connection, preferably all second plug-in connections of the locating bearing side each be designed in the fixing position thereof that connects the cooling elements, to have restricted movability in the direction that is orthogonal to the plane of the cooling elements and in the directions that are parallel to the plane of the cooling elements.

An especially practical embodiment is provided where the plug-in connection releasably connects the cooling elements, thereby allowing them to be separated and spaced apart from one another or replaced if maintenance is needed or in the event of damage. Another especially recommended slight variation provides that at least one plug-in connection be configured as a snap-fit connection, so that, upon reaching the predetermined nominal position, the connection automatically snaps into place and thereby reliably positionally secures the thus adjusted position. If the snap-fit connection has a releasable design, the snap-fit connection may also be released exclusively by using an appropriate tool, for example. It has proven to be particularly advantageous for the snap-fit connection of at least a second, in particular of all second plug-in connections of the locating bearing side to be equipped with a snap-fit connection and to thereby readily realize the fixing of the cooling elements to one another. The snap-fit connection preferably functions in the direction that is orthogonal to the plane of the cooling elements. Thus, it prevents a movement of the cooling elements counter to the second assembly direction.

The snap-fit connections are constituted of an undercut, which is preferably configured on the male connector member, and of at least one latching clip, which, in the fixing position, embraces the undercut and is preferably configured on the sleeve.

A further refinement of the present invention is suited for compensating for different thermal expansions, as may be realized in accordance with the present invention. It provides that a cooling element, in particular an intercooler or a high-temperature radiator, be traversable by the flow of gaseous coolant, preferably for a radiator coolant temperature of up to 100° C. above a liquid coolant of another cooling element, in particular of a radiator or low-temperature radiator.

In practice, it is also especially helpful when the cooling elements, in particular the radiator having the intercooler, are connected to four plug-in connections that are pairwise identical in design and/or equivalent in function, making modular expandability readily possible, particularly when cooling devices are used in already existing motor vehicles. To this end, at least two second plug-in connections are provided on the locating bearing side. It is advantageous that at least two of the latching clips of the two plug-in connections be oriented transversely to each other. This makes it hereby possible to compensate for the wear or the failure of individual latching clips.

One especially advantageous further refinement of the present invention relates to the embodiment where at least one of the plug-in connections has a recess for receiving an additional connection means. A screw and/or a clamp are/is provided as a connection means, for example. On the one hand, the connection means may be used for vehicles having an increased load, such as sport vehicles or all-terrain vehicles. On the other hand, a simple and readily available fixing in position is made possible through the use of the connection means, for example as an after-sales service solution in the event of failure of one or of a plurality of the latching clips. The recess for receiving the connection means is preferably configured in the male connector member and/or the sleeve of at least one of the second plug-in connections.

One special embodiment provides that the recess be sealed until first-time use by a film element of small wall thickness that is formed in one piece with the male connector member and/or the sleeve. The 0.1 to 0.5 millimeter, preferably 0.2 millimeter thick film element prevents the ingress of contamination into the recess or into the plug-in connection. To assemble the connection means, the film element is pierced through by the connection means or by a tool.

The present invention permits numerous specific embodiments. To further illustrate the basic principle thereof, some of these are illustrated in the drawing and are described below. They show in:

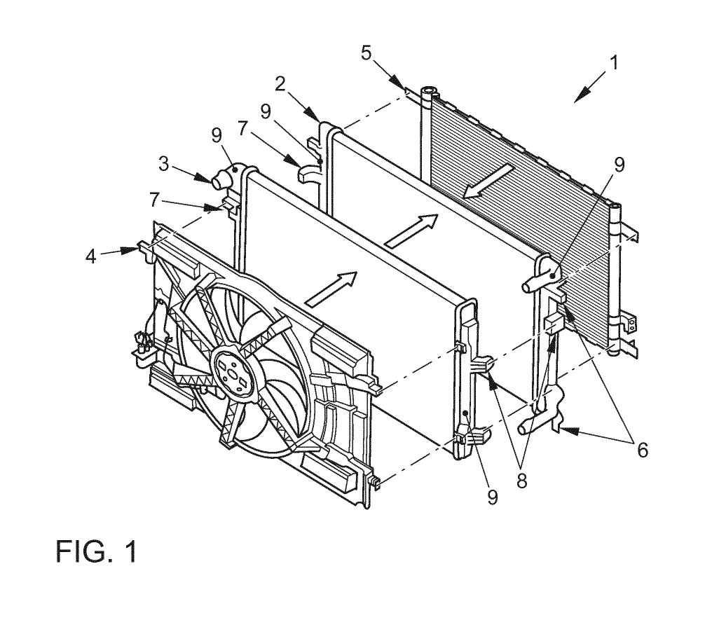

FIG. 1 a schematic spatial representation of the assembly of a first specific embodiment of a cooling device;

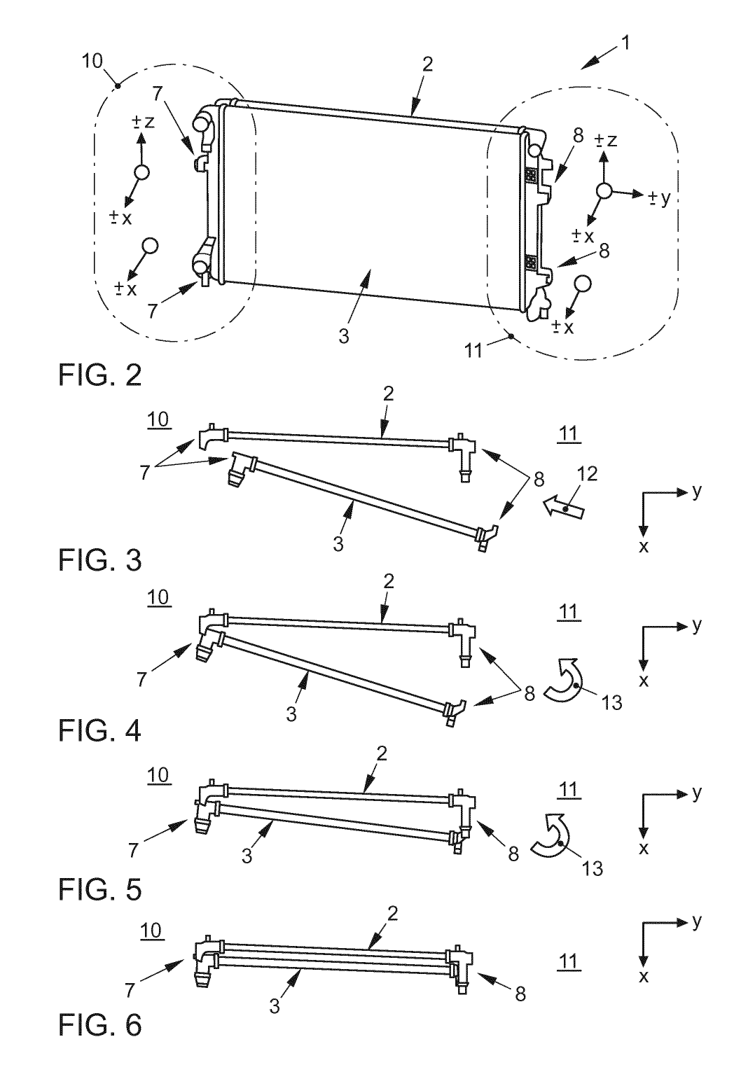

FIG. 2 a schematic representation of a view of the cooling device shown in FIG. 1;

FIG. 3 a schematic representation of a plan view of the cooling device shown in FIG. 1 during assembly of two cooling elements in a first assembly step;

FIG. 4 a schematic representation of a plan view of the cooling device shown in FIG. 1 during assembly of two cooling elements in a second assembly step;

FIG. 5 a schematic representation of a plan view of the cooling device shown in FIG. 1 during assembly of two cooling elements in a third assembly step;

FIG. 6 a schematic representation of a plan view of the cooling device shown in FIG. 1 following assembly of two cooling elements in the end position of the cooling elements;

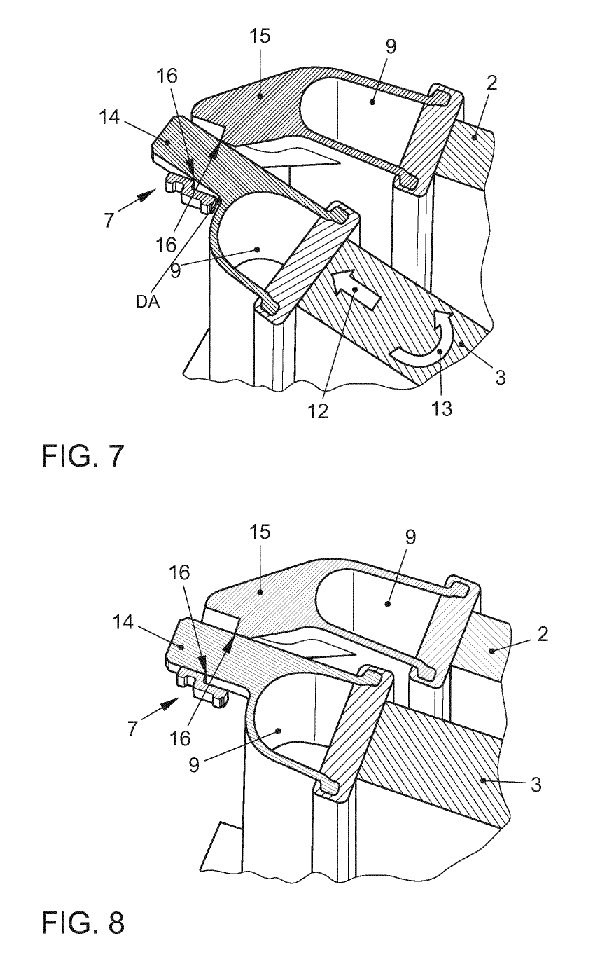

FIG. 7 a schematic representation of the two cooling elements shown in FIG. 3 through 6 during assembly in an enlarged sectional representation of a non-locating bearing side;

FIG. 8 a schematic representation of the two cooling elements shown in FIG. 3 through 6 in the fixing position in an enlarged sectional representation of a non-locating bearing side;

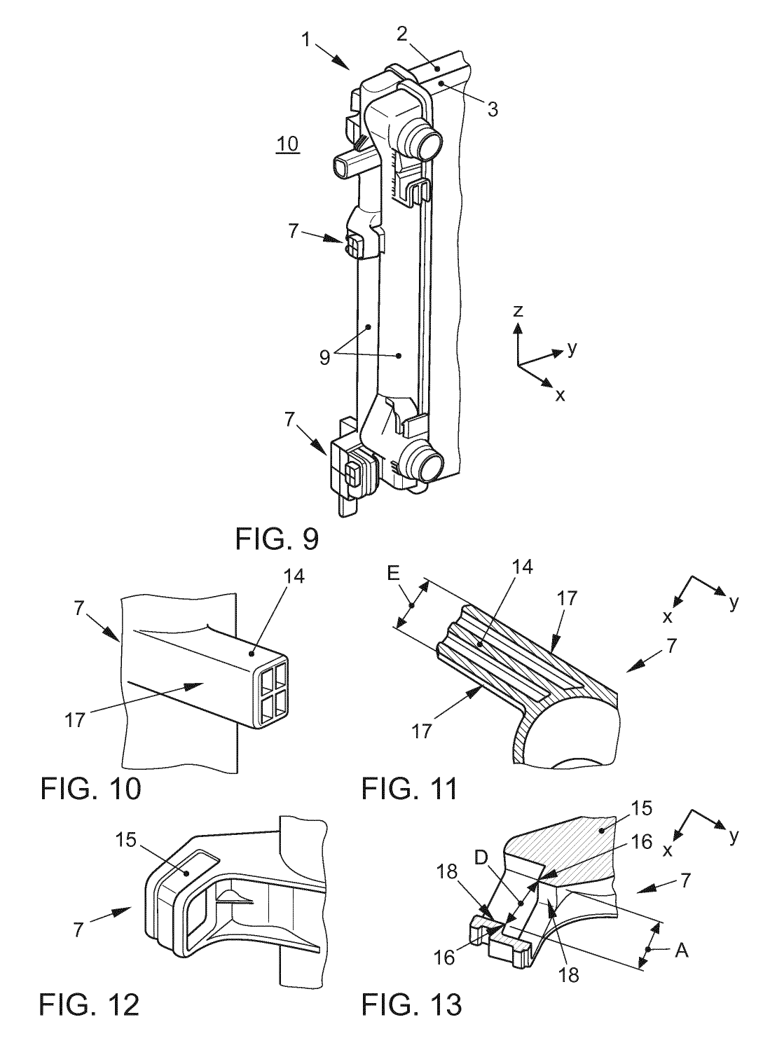

FIG. 9 a schematic representation of two variants of a plug-in connection of a non-locating bearing side of the cooling device shown in FIG. 1;

FIG. 10 a schematic representation of the first variant of the plug-in connection shown in FIG. 9;

FIG. 11 a schematic representation of the first variant of the plug-in connection shown in FIG. 9;

FIG. 12 a schematic representation of the first variant of the plug-in connection shown in FIG. 9;

FIG. 13 a schematic representation of the first variant of the plug-in connection shown in FIG. 9;

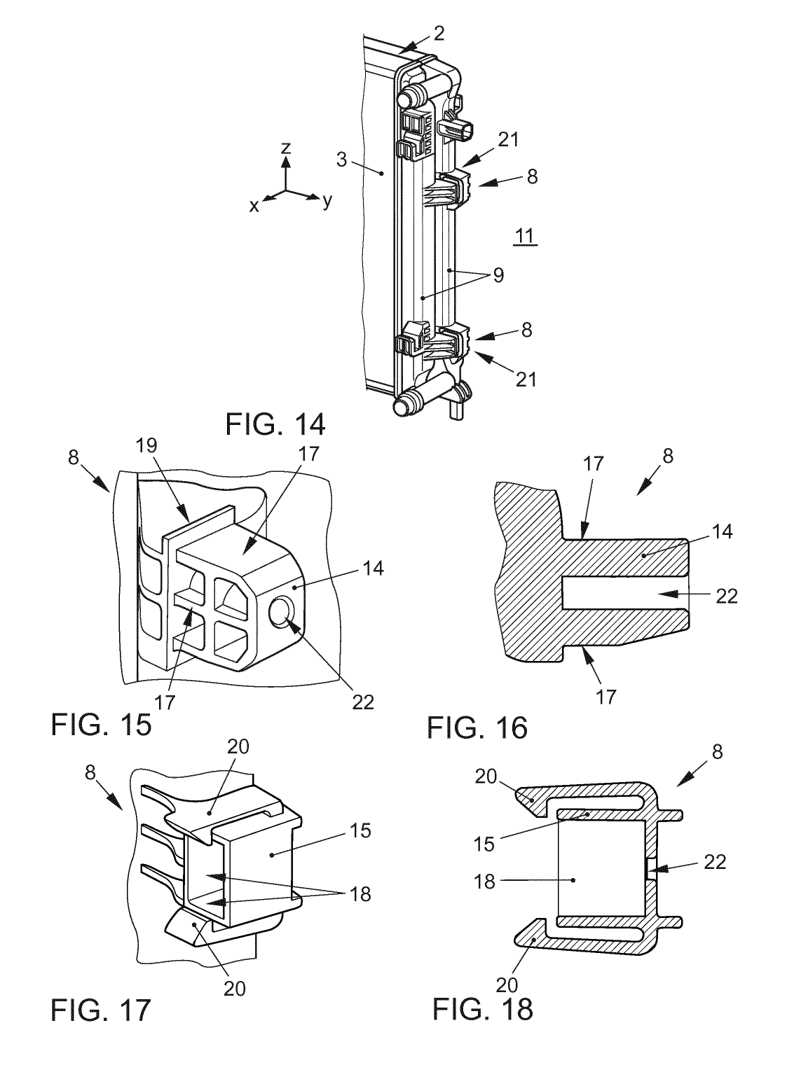

FIG. 14 a schematic representation of two variants of a plug-in connection of a locating bearing side of the cooling device shown in FIG. 1;

FIG. 15 a schematic representation of the first variant of the plug-in connection shown in FIG. 14;

FIG. 16 a schematic representation of the first variant of the plug-in connection shown in FIG. 14;

FIG. 17 a schematic representation of the first variant of the plug-in connection shown in FIG. 14;

FIG. 18 a schematic representation of the first variant of the plug-in connection shown in FIG. 14;

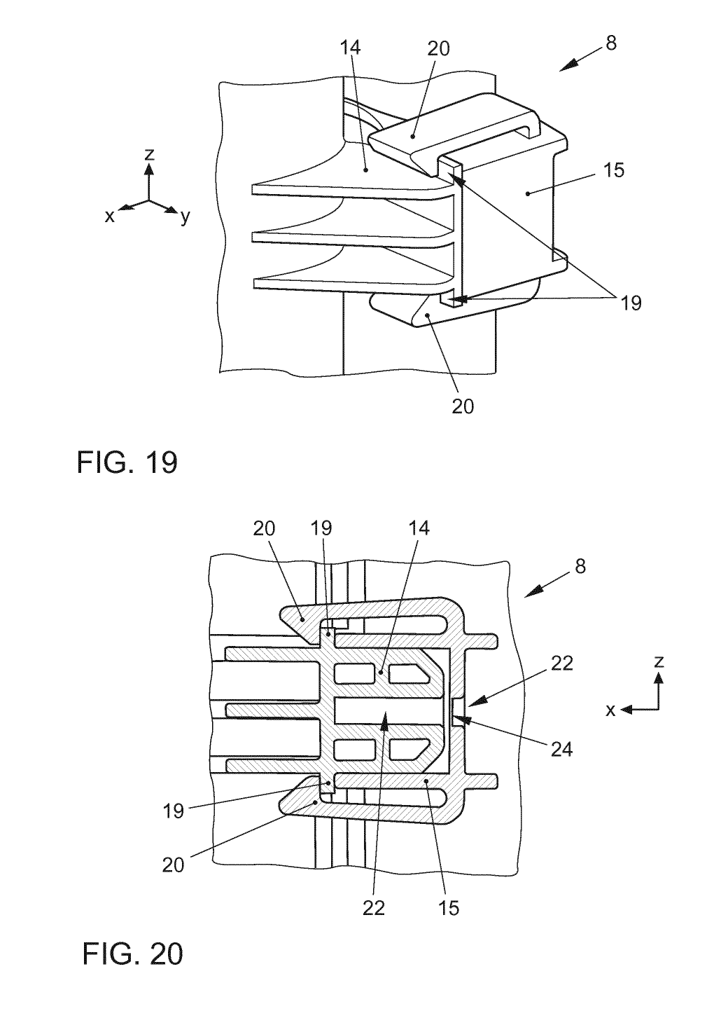

FIG. 19 a schematic representation of the first variant of the plug-in connection of the locating bearing side in the fixing position in an enlarged view;

FIG. 20 a schematic representation of the first variant of the plug-in connection of the locating bearing side in the fixing position in an enlarged sectional view;

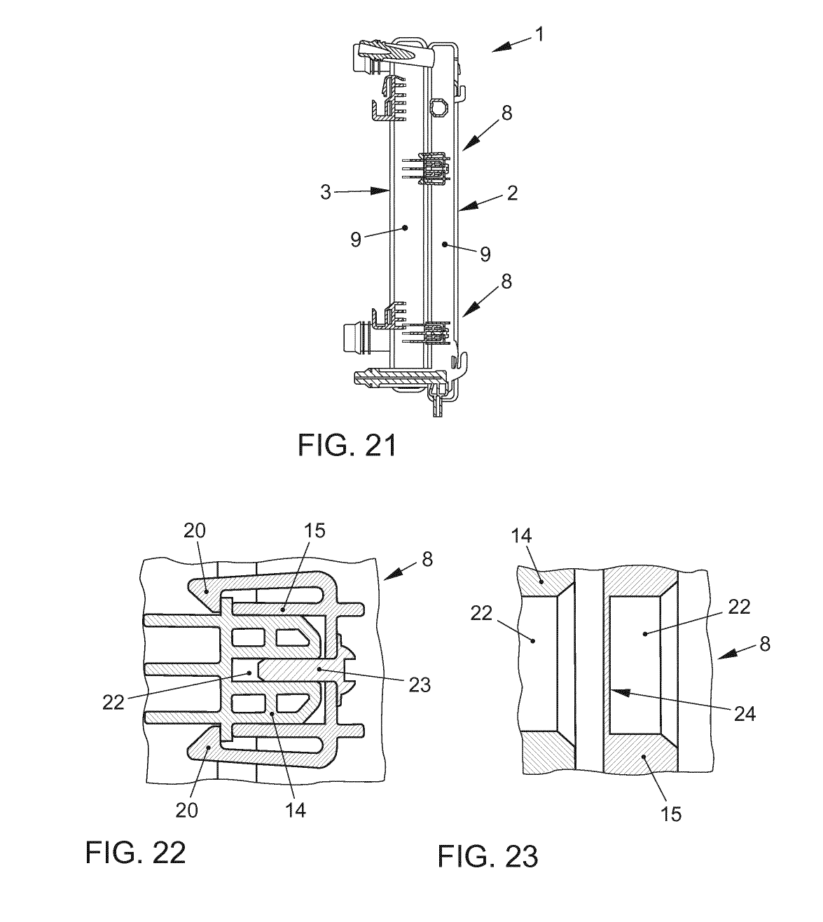

FIG. 21 a schematic representation of a detail view of a second specific embodiment of a cooling device having a first variant of a connection means;

FIG. 22 a schematic representation of an enlarged detail view of the cooling device shown in FIG. 21, including the plug-in connection of the locating bearing side including the first variant of the connection means in a sectional view;

FIG. 23 a schematic representation of another enlarged detail view of the plug-in connection of the locating bearing side shown in FIG. 22, including the first variant of the connection means in a sectional view;

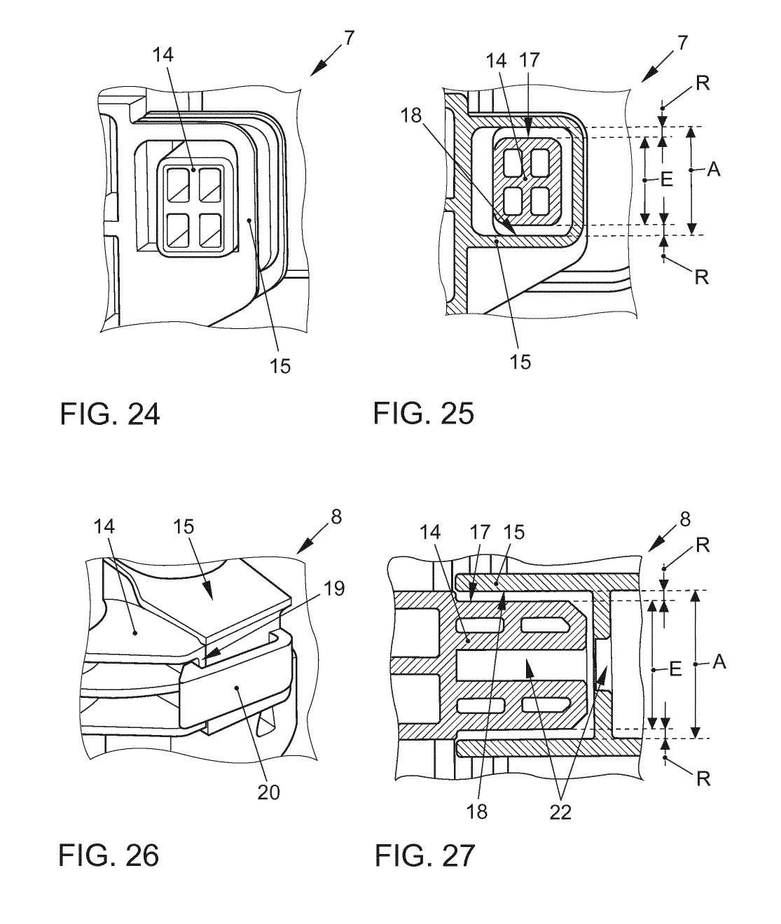

FIG. 24 a schematic representation of an enlarged detail view of a third specific embodiment of a cooling device including a special embodiment of individual plug-in connections of the non-locating bearing side;

FIG. 25 a schematic representation of an enlarged detail view of a third specific embodiment of a cooling device including a special embodiment of individual plug-in connections of the non-locating bearing side;

FIG. 26 a schematic representation of an enlarged detail view of a third specific embodiment of a cooling device including a special embodiment of individual plug-in connections of the locating bearing side;

FIG. 27 a schematic representation of an enlarged detail view of a third specific embodiment of a cooling device including a special embodiment of individual plug-in connections of the locating bearing side;

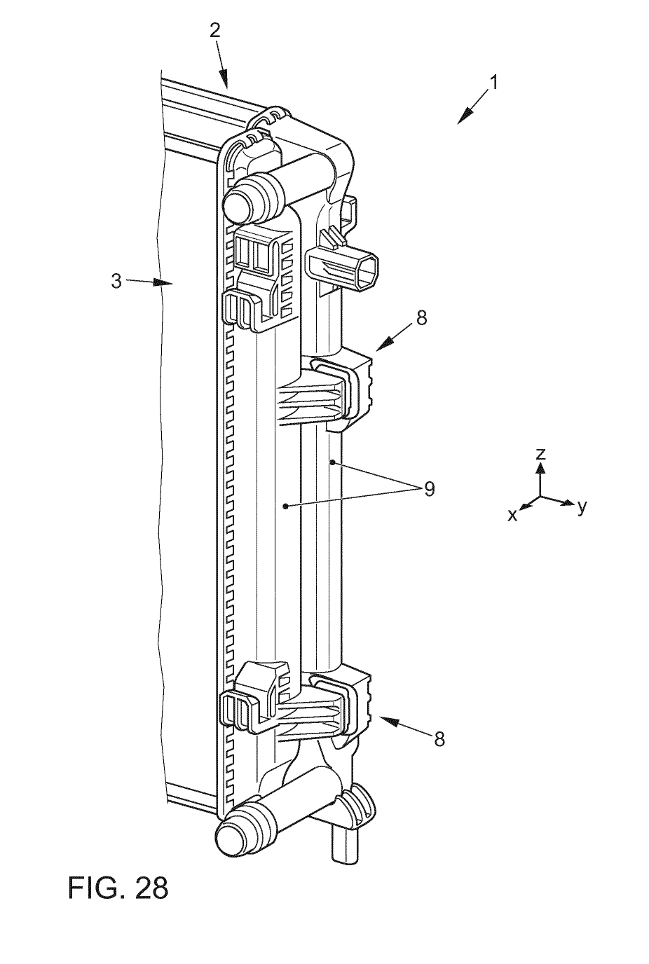

FIG. 28 a schematic representation of a detail view of a fourth specific embodiment of a cooling device including a second variant of a connection means;

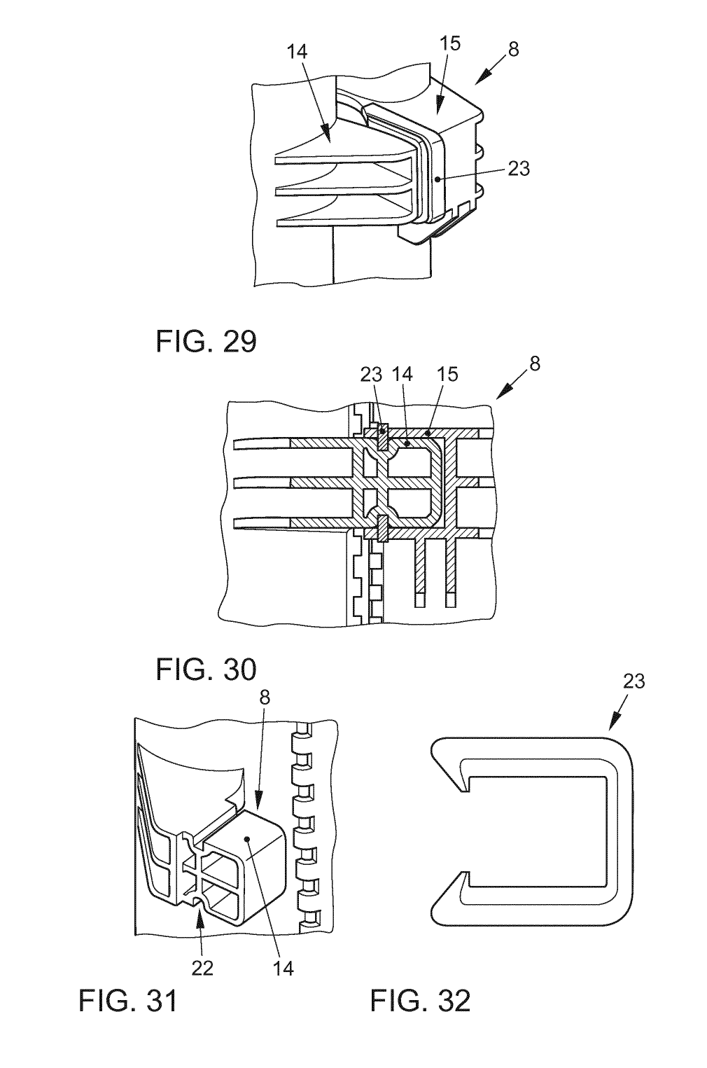

FIG. 29 a schematic representation of an enlarged detail view of the cooling device shown in FIG. 28, including the plug-in connection of the locating bearing side including the second variant of the connection means in a view;

FIG. 30 a schematic representation of an enlarged detail view of the cooling device shown in FIG. 28, including the plug-in connection of the locating bearing side including the second variant of the connection means in a sectional view;

FIG. 31 the male connector member of the plug-in connection of the locating bearing side in a schematic representation of an enlarged detail view of the cooling device shown in FIG. 28;

FIG. 32 the second variant of the connection means of the plug-in connection of the locating bearing side in a schematic representation of an enlarged detail view of the cooling device shown in FIG. 28.

FIG. 1 shows a cooling device 1 for a motor vehicle (not specifically shown). As cooling elements 2, 3, cooling device 1 includes a low-temperature radiator 2 and a high-temperature radiator 3. A fan shroud 4 and a condenser 5 constitute other cooling elements 4, 5. At least cooling elements 2, 3 are successively disposed in different parallel planes to allow the incoming ambient air to flow therethrough. Flanges 6 are configured on low-temperature radiator 2 for connecting cooling device 1 to the vehicle. All of the forces of cooling device 1 are directed into the vehicle via flanges 6. The other cooling elements 3, 4, 5 are indirectly and/or directly fixed to low-temperature radiator 2. Plug-in connections 7, 8 are provided for interconnecting cooling elements 2, 3, 4, 5, in particular of low-temperature radiator 2 and of high-temperature radiator 3. Plug-in connections 7, 8 are configured on opposite rims of cooling elements 2, 3, 4, 5. In the case of illustrated low-temperature radiator 2 and high-temperature radiator 3, plug-in connections 7, 8 are disposed on collecting devices 9 of the radiators. The broken arrows schematically indicate the sequence of assembling cooling elements 2, 3, 4, 5 to one another. Preferably, condenser 5 is first fixed to low-temperature radiator 2, and then low-temperature radiator 2 to the vehicle. High-temperature radiator 3 is subsequently initially fastened to low-temperature radiator 2, and fan shroud 4 then to high-temperature radiator 3.

FIG. 2 shows a schematic representation of cooling device 1. Plug-in connections 7, 8 have at least functionally different designs on both sides of cooling elements 2, 3. On a side of cooling elements 2, 3, referred to as non-locating bearing side 10, two first plug-in connections 7 are provided. A translational movement of the two cooling elements 2, 3 relative to each other and parallel to first spatial axis designated by Y is possible on non-locating bearing side 10. To this end, it suffices when a translational movement of cooling elements 2, 3 relative to each other and parallel to second spatial axis X and third spatial axis Z is suppressed in each case by at least one of the two first plug-in connections 7. In the illustrated specific embodiment, a first plug-in connection 7 is formed as an abutment that functions parallel to second spatial axis X, and the other first plug-in connection 7 is designed as an abutment that functions parallel to second spatial axis X and third spatial axis Z. On a side of cooling elements 2, 3, referred to as locating bearing side 11, two second plug-in connections 8 are provided. A translational movement of the two cooling elements 2, 3 relative to each other and parallel to all three spatial axes X, Y, Z is blocked on locating bearing side 11. This requires that at least one of the two second plug-in connections 8 suppress the translational movement of cooling elements 2, 3 relative to each other and parallel to spatial axes X, Y and Z. In the illustrated specific embodiment, a second plug-in connection 8 is formed as an abutment that functions parallel to all spatial axes X, Y, Z, and the other second plug-in connection 8 is designed as an abutment that functions parallel to second spatial axis X. In this case, non-locating bearing side 10 and locating bearing side 11 include the two opposite edges, here the two opposite collecting devices 9 of cooling elements 2, 3.

To clarify the assembly steps according to the present invention for fixing cooling elements 2, 3 to each other, FIG. 3 through 6 show plan views of cooling elements 2, 3. First assembly step is shown in FIG. 3. In a first assembly direction 12, high-temperature radiator 3 is moved translationally toward low-temperature radiator 2. The two cooling elements 2, 3 subtend an angle of 15 degrees. On non-locating bearing side 10, first plug-in connections 7 are inserted one into the other. This insertion is shown in an enlarged view in FIG. 7. The second assembly step is shown in FIG. 4. Once first plug-in connections 7 have been inserted, and cooling elements 2, 3 have reached stop position thereof in first assembly direction 12, high-temperature radiator 3 is moved rotationally toward low-temperature radiator 2 in a second assembly direction 13. The angle between the two cooling elements 2, 3 is reduced to approximately 5 degrees. FIG. 5 shows how, in the third assembly step, second plug-in connections 8 of locating bearing side 11 are guided one into the other. At least cooling element 3 is moved further in second assembly direction 13 until second plug-in connections 8 lock in place, and the two cooling elements 2, 3 are fixed to each other. Finally, FIG. 6 shows held-together cooling elements 2, 3 in the fixing position thereof. To attain the fixing position, the two cooling elements 2, 3 are interconnected by plug-in connections 7, 8, at least one first plug-in connection 7 being movably designed parallel to first assembly direction 12, and at least one second plug-in connection 8 being movably designed parallel to second assembly direction 13, transversely to first assembly direction 12. In the fixing position thereof, at least first plug-in connections 7 are movably designed parallel to at least one first spatial axis Y.

In an enlarged sectional representation, FIGS. 7 and 8 show non-locating bearing side 10 of the two cooling elements 2, 3 shown in FIG. 3 through 6. FIG. 7 shows the assembly of cooling elements 2, 3 to each other, and FIG. 8 shows the fixing position of cooling elements 2, 3 attained at the end of the assembly. Plug-in connections 7, 8, also of locating bearing side 11 shown, inter alia, in FIGS. 19 and 20 are constituted of a male connector member 14 and of a sleeve 15. In the illustrated specific embodiment, male connector member 14 is configured on high-temperature radiator 3, and sleeve 15 on low-temperature radiator 2. During assembly and in the fixing position, sleeve 15 receives male connector member 14. During assembly, male connector member 14 is guided by two end edges 16 formed in sleeve 15, as shown in FIG. 13, respectively held by end edges 16 during the movement of one cooling element 3 in second assembly direction 13. Here, the significant advantage is derived that simple insertion of male connector member 14 is enabled in a first position. In a second end position, male connector member 14 is held securely between end edges 16. Upon rotation, the male connector member has a first degree of freedom in first assembly direction 12. Moreover, a rotational movement of male connector member 14 about axis of rotation DA is possible. Male connector member 14 also permits a displacement counter to first assembly direction 12, making it simpler for male connector member 14 to be positioned during assembly thereof. This is accomplished by the step-like embodiment of the bounding surfaces. In addition, a secure and fixed retention is ensured in the end position.

FIG. 9 through 13 show first plug-in connection 7 of non-locating bearing side 10. In a detail view of cooling device 1, FIG. 9 shows non-locating bearing side 10 including two first plug-in connections 7. Plug-in connections 7 are configured on collecting devices 9 of cooling elements 2, 3. A male connector member 14 of first plug-in connection 7 is shown in FIG. 10 in one view and, in FIG. 11, in a sectional view. Male connector member 14 has a rectangular cross section having rounded edges. In addition, male connector member 14 has at least two plane-parallel friction surfaces 17. A sleeve 15 of first plug-in connection 7 is shown in FIG. 12 in one view and, in FIG. 13, in a sectional view. Sleeve 15 is provided for receiving male connector member 14. Sleeve 15 encompasses two plane-parallel bounding surfaces 18, against which, in the fixing position, friction surfaces 17 of male connector member 14 engage form-fittingly, thereby forming an abutment. Interspacing A of bounding surfaces 18 is slightly larger than distance E of friction surfaces 17 relative to each other. To enable male connector member 14 to be inserted into sleeve 15 in response to movement in first assembly direction 12, bounding surfaces 18 of sleeves 15 of first plug-in connection 7 feature mutually facing end edges 16, whose mutual distance D is greater than interspacing A of bounding surfaces 18. In the fixing position that connects cooling elements 2, 3, first plug-in connections 7 of non-locating bearing side 10 are each immovably designed as abutments in second spatial axis X that is orthogonal to cooling elements 2, 3. Bounding surfaces 18 are disposed parallel to each other, however, at an offset relative to the first spatial axis. The result is a stepped formation. It is thus simpler to position male connector member 14 (not shown here) during assembly thereof. In addition, a secure and fixed retention is ensured in the end position.

FIG. 14 through 18 show second plug-in connection 8 of locating bearing side 11. In a detail view of cooling device 1, FIG. 14 shows locating bearing side 11 including two variants of second plug-in connection 8. Plug-in connections 8 are configured on collecting devices 9 of cooling elements 2, 3. A male connector member 14 of second plug-in connection 8 is shown in FIG. 15 in one view and, in FIG. 16, in a sectional view. Male connector member 14 has a rectangular cross section having rounded edges. In addition, male connector member 14 has at least two plane-parallel friction surfaces 17. A sleeve 15 of second plug-in connection 8 is shown in FIG. 17 in one view and, in FIG. 18, in a sectional view. Sleeve 15 is provided for receiving male connector member 14. Sleeve 15 encompasses two plane-parallel bounding surfaces 18, against which, in the fixing position, friction surfaces 17 of male connector member 14 engage form-fittingly, thereby forming an abutment. The interspacing of bounding surfaces 18 is slightly larger than or equal to the mutual distance of friction surfaces 17. In the end position, the transition is preferably free of gaps. Second plug-in connection 8 of locating bearing side 11 features a snap-fit connection 21 constituted of at least one undercut 19 and of at least one latching clip 20, which, in the fixing position, grips around undercut 19. In the fixing position, in the direction of second spatial axis X that is orthogonal to the plane of cooling elements 2, 3, snap-fit connection 21 fixes cooling elements 2, 3 in position. In accordance with the illustrated specific embodiment, undercut 19 is configured on male connector member 14, and at least one latching clip 20 is provided on male connector member 15. Recesses 22 shown in FIG. 20 are provided in male connector member 14 and sleeve 15. Recesses 22 serve for receiving an additional connection means 23, as illustrated in FIGS. 21 through 23 and 28 through 31.

FIGS. 19 and 20 show enlarged representations of second plug-in connection 8 of locating bearing side 11 in fixing position 11. FIG. 19 shows a view of second plug-in connection 8, and FIG. 20 shows a section through second plug-in connection 8. In the first variant of second plug-in connection 8 shown here, two latching clips 20, which are positioned mutually in parallel on two opposite sides of sleeve 15, are provided on one sleeve 15. The redundancy provided by two latching clips 20 permits a compensation in case one of latching clips 20 is subject to wear. Externally, latching clips 20 are associated with sleeve 15 and extend virtually over the entire length of sleeve 15. These features facilitate assembly. In the fixing position thereof that connects cooling elements 2, 3, second plug-in connection 8 of locating bearing side 11 is immovably designed as an abutment in the direction of second spatial axis X that is orthogonal to the plane of cooling elements 2, 3 and in the direction of first spatial axis Y and third spatial axis Z that are parallel to the plane of cooling elements 2, 3.

FIGS. 21 through 23 show a second specific embodiment of cooling device 1. This specific embodiment provides that, besides snap-fit connection 21, plug-in connection 8 of locating bearing side 11 be additionally fixed and secured by a first variant of a connection means 23. In the illustrated first variant, connection means 23 is a screw that releasably connects sleeve 15 and male connector member 14 by interlocking and/or frictional engagement. The configuration of connection means 23 is provided, for example, in the case of repairing and/or retrofitting of cooling device 1, in particular in the case of plug-in connection 8. To facilitate the assembly of additional connection means 23, mutually concentric recesses 22 are provided in each case in male connector member 14 and sleeve 15. Recesses 22 are also shown in FIGS. 15, 16 and 18 and serve for receiving connection means 23, as illustrated in FIGS. 12 and 22. Generally, however, additional connection means 23 are not necessary. For that reason, until connection means 23 are received for the first time, at least recess 22 of sleeve 15 is sealed by a film element 24 of small wall thickness that is formed in one piece with sleeve 15. FIG. 23 shows this state. Film element 24 prevents the ingress of contamination into recesses 22 and into plug-in connection 8. When connection means 23 are assembled for the first time, film element 24 is pierced through by connection means 23 or by a tool and is destroyed. FIGS. 24 through 27 show an enlarged detail view of a third specific embodiment of cooling device 1. FIGS. 24 and 25 show a second variant of first plug-in connection 7 of non-locating bearing side 10, and FIGS. 26 and 27 show a second variant of second plug-in connection 8 of locating bearing side 11. In contrast to the first variant of plug-in connections 7, 8 shown in FIG. 9 through 18, interspacing A of bounding surfaces 18 of sleeve 15 in these second variants is significantly larger than mutual distance E of friction surfaces 17 of male connector member 14. In the second variant of plug-in connections 7, 8, interspace R between mutually opposing friction surfaces 17 and bounding surfaces 18 is approximately 1.5 millimeters. This makes it possible to compensate for tolerances in the direction of third spatial axis Z. In the first variant of plug-in connections 7, 8, this interspace R is smaller than 0.5 millimeter and is preferably approximately 0.1 millimeter. Moreover, sleeve 15 of the second variant of second plug-in connection 8 of locating bearing side 11 includes a latching clip 20 that is oriented transversely to latching clips 20 of the first variant of second plug-in connection 8 of locating bearing side 11.

FIG. 28 through 32 show a detail view of a fourth specific embodiment of cooling device 1 having a second variant of a connection means 23. In this specific embodiment, the releasable positional fixation of male connector member 14 and of sleeve 15 to each other is realized on locating bearing side 11 by the second variant of a connection means 23. This connection means 23 is a clamp shown in FIG. 32 that is configured in recesses 22 of male connector member 14 and sleeve 15. Recesses 22 for receiving the second variant of a connection means 23 are configured as aligned grooves. In another specific embodiment of cooling device 1 that does not appear in the figures, the second variant of a connection means 23 extends around latching clips 20 of a snap-fit connection 21, as is shown, inter alia, in FIGS. 19 and 26.

### REFERENCE NUMERAL LIST

1 cooling device
   cooling element
2 low-temperature radiator
   cooling element
3 high-temperature radiator
4 cooling element, fan shroud
5 cooling element, condenser
6 flange
7 first plug-in connection
8 second plug-in connection
9 collecting device
10 non-locating bearing side
11 locating bearing side
12 first assembly direction
13 second assembly direction
14 male connector member
15 sleeve
16 end edge
17 friction surface
18 bounding surface
19 undercut
20 latching clip
21 snap-fit connection
22 recess
23 connection means
24 film element
A interspacing (bounding surfaces)
D distance (end edges)
E distance (friction surfaces)
R interspace
X second spatial axis
Y first spatial axis
Z third spatial axis
DA axis of rotation

1. A cooling device for a motor vehicle, the cooling device comprising:
at least two cooling elements that are successively disposed in different, parallel planes adapted to allow incoming ambient air to flow therethrough, and that are interconnected by plug-in connections;
wherein at least one first plug-in connection is configured to move along a first spatial axis (Y), and
wherein at least one second plug-in connection is configured to move along a second spatial axis (X) transversely to the first spatial axis (Y), and, in a fixing position thereof that connects the at least two cooling elements,
wherein at least one of the first plug-in connections is configured to have restricted movability in each case in the plane parallel to the at least two cooling elements in the direction of at least one spatial axis (Y),
wherein the at least one first plug-in connection, which forms a non-locating bearing side, is configured on a first edge of the at least two cooling elements; and
wherein the at least one second plug-in connection, which forms a locating bearing side, is configured on a second edge opposite the first edge.

2. The cooling device for a motor vehicle as recited in claim 1,
wherein the plug-in connections comprise a male connector member located on one of the at least two cooling elements and a sleeve configured to receive the male connector member in the fixing position when the at least two cooling elements are assembled to each other.

3. The cooling device for a motor vehicle as recited in claim 1,
wherein the at least one first plug-in connection has an assembly direction that is oriented at an angle of less than 30 degrees to the plane of the at least two cooling elements; and/or
wherein the at least one second plug-in connection has an assembly direction oriented orthogonally to the plane of the at least two cooling elements.

4. The cooling device for a motor vehicle as recited in claim 1,
wherein the sleeve has two plane-parallel bounding surfaces that are associated in the fixing position with plane-parallel friction surfaces of the male connector member; and/or
wherein an interspacing thereof is slightly larger than a distance (E) of the friction surfaces relative to each other, and/or
wherein relative to the first spatial axis (Y), the bounding surfaces are disposed so as to be offset from one another.

5. The cooling device for a motor vehicle as recited claim 4,
wherein the bounding surfaces of the sleeve of at least one first plug-in connection comprise mutually facing end edges whose mutual distance (D) is greater than the interspacing (A) of the bounding surfaces.

6. The cooling device for a motor vehicle as recited in claim 1,
wherein, in the fixing position thereof that connects the at least two cooling elements, a the at least one first plug-in connection of the non-locating bearing side is immovably oriented in the second spatial axis (X) that is orthogonal to the plane of the at least two cooling elements; and/or,
wherein, in the fixing position thereof that connects the cooling elements, the at least one second plug-in connection of the locating bearing side is immovably oriented in each case in the direction of the second spatial axis (X) that is orthogonal to the plane of the at least two cooling elements and in the direction of the first spatial axis (Y) and a third spatial axis (Z) that are parallel to the plane of the at least two cooling elements.

7. The cooling device for a motor vehicle as recited in claim 1,
wherein, in the fixing position thereof that connects the at least two cooling elements, the at least one second plug-in connection of the locating bearing side is fixed in each case by a snap-fit connection in a direction that is orthogonal to the plane of the at least two cooling elements.

8. The cooling device for a motor vehicle as recited in claim 1,
wherein the snap-fit connection comprises an undercut located on the male connector member and of at least one latching clip, which, in the fixing position, embraces the undercut and is located on the sleeve.

9. The cooling device for a motor vehicle as recited in claim 1,
wherein at least two second plug-in connections are provided on the locating bearing side, at least two latching clips of the at least two plug-in connections being oriented transversely to each other.

10. The cooling device for a motor vehicle as recited claim 2,
wherein, in the case of at least one second plug-in connection, a recess for receiving an additional connection means is provided in the male connector member and/or the sleeve.

11. The cooling device for a motor vehicle as recited in claim 1,
wherein the first edge is a first collecting device of the at least two cooling members.

12. The cooling device for a motor vehicle as recited in claim 1,
wherein the second edge is a second collecting device of the at least two cooling members.
